(19) United States
(12) Patent Application Publication
(10) Pub. No.: US 2013/0103750 A1
(43) Pub. Date: Apr. 25, 2013

(54) INTERACTIVE PLATFORM FOR THE TRUCKING INDUSTRY

(71) Applicant: Taleb Jamal Awad, Oak Lawn, IL (US)

(72) Inventor: Taleb Jamal Awad, Oak Lawn, IL (US)

(21) Appl. No.: 13/659,741

(22) Filed: Oct. 24, 2012

Related U.S. Application Data
(60) Provisional application No. 61/550,591, filed on Oct. 24, 2011.

(51) Int. Cl. G06F 15/16

(52) U.S. Cl. 709/203

(57) ABSTRACT

The present invention is an interactive platform for the trucking industry such that truck drivers and those that interact with them can create and exchange information.

### CROSS-REFERENCE TO RELATED APPLICATIONS

This application claims priority to U.S. Provisional Application No. 61/550,591, filed Oct. 24, 2011, which is incorporated by reference herein in its entirety.

### FIELD OF THE INVENTION

The invention relates generally to a social media. More specifically, the invention relates to an interactive platform known as a social network through which individuals and communities create and share information including user-generated content. According to the invention, the social network is specifically designed for the trucking industry including truck drivers and those that interact with them such as brokers, distributors, and dispatchers.

### BACKGROUND OF THE INVENTION

Social network websites and applications are continuously increasing in popularity. A social network is a social structure made up of users such as individuals or organizations that are interconnected by a common interest. The social network provides an interactive platform that facilitates the exchange of information including user-generated content.

More specifically, social networks are typically online communities of users who share interests and activities, or who are interested in exploring the interests and activities of others. Social networks provide a variety of ways for users to interact, such as through instant messaging, e-mail messaging or posting and sharing content for all users, or a select few, to view.

Social networks provide several advantages. Social networks facilitate connections with users sharing the same or similar interest. Social networks also provide a means of communication and provide up-to-date information. For example, a user may keep informed on recent happenings with other users within the social network. Social networks may provide understanding and education on a particular interest or activity and allow users to band together to create strong alliances for a certain cause. However, a social network that is specifically designed for the trucking industry including truck drivers and those that interact with them such as brokers, distributors, and dispatchers fails to exist.

It would be useful to have an interactive platform through which truck drivers and those that interact with them could create and share information including user-generated content. The present invention satisfies this demand.

### SUMMARY OF THE INVENTION

The present invention is an interactive platform (otherwise referred to herein as a “social network” or “vehicle social network”) that facilitates the creation and exchange of information, data and content related to the trucking industry.

For purposes of this application, the vehicle social network is discussed herein with reference to semi-trucks, but any vehicle is contemplated, for example, construction vehicles such as dump trucks, water vessels, and aircrafts to name a few.

The interactive platform may be based on an Internet application including an interface that is accessible through a display of a device such as computers, mobile devices, hand-held devices, cell phones, laptops, tablets, DVR, smart card, digital book reader, to name a few.

Users of the present invention are contemplated to be any individual or entity within the trucking industry including truck drivers (otherwise referred to as “truckers”), dispatchers, brokers, distributors, receiving companies, shipping companies, transportation companies, organizations such as the Teamsters Union, Owner-Operator Independent Driver Association, or American Trucking Association, to name a few. It is also contemplated that individuals or entities within the trucking industry may be gas stations, rest areas, restaurants, hotels, and mechanics.

The interface provides access to a user home page. The user home page may be accessed directly or through a shortcut on the display of the device. The home page is the personal web page specific to the user and is private in that it is not accessible or viewable to the other users of the interactive platform. The user creates content through the home page.

A profile page is shared with other users of the social network. A user posts content to the profile page through the user's home page.

A variety of content may be created and shared such as adding users as friends, exchange messages including automatic notifications such as when a user updates their profile or when their status changes. For example, a driver may communicate delays such as that due to an extended unloading time period, maintenance at a service station, or flat tire.

Content may also include attributes of a vehicle, characteristics of a driver, location of the vehicle, the driver's log, fuel usage, speed, gear optimization, engine idle time, direction of travel, amount of time spent driving as well as advertising and incentives such as discounts and coupons for products and services based upon the location of the user. For example, once a semi-truck enters a metropolitan or surrounding area, discounts can be sent to the user for local lodging, food, and entertainment. It is also contemplated that the user may sign up or subscribe to certain services that offer discounts and coupons.

Content may also include real-time location of a vehicle. For example, users may track the location of a particular vehicle including whether the vehicle is in transit or stationary. This information may be useful for a driver to plan arrival at a destination simultaneously with another driver in order to meet one another. As another example, a transportation company may use location information to identify the status of truck delivery or pick-up of goods at a particular location.

The interface may also include status identifiers. Status identifiers may include a variety of icons. For example, one icon may be a horn that can be clicked by a mouse or other computer input device to signal “hello” to a user when his or her home page is visited by another user. It is also contemplated that the icon may be a bent arm generally in a L-shape that is raised and lowered to signal “hello”.

Other icons can represent macros for each stage of the loading and unloading process, such as “waiting in line to pick up load”, “loaded and leaving shipper” and “arrived at final destination”. It is also contemplated that icons can represent a variety of other information such as “sleeping”, “eating”, “in-transit”, or “leave me alone”.

The user home page may allow users to download information from other users or from the Internet to post publicly on the user's profile page to all users in the social network. For example, a user may download and post a joke-of-the-day or horoscope.

The social network may also include games such as card games users can play with one another. It is contemplated that the games may be skill or knowledge based.

The social network may also include contests and the award of prizes, either monetary or non-monetary such as a free night stay at a hotel. Contests may include a competition between trucks and a prize awarded for the most “tricked-out” truck, for example.

The interactive platform permits bi-directional communication between users. The interface of the vehicle social network includes at least one processor along with one or more external devices. Connection between the processor and one or more external devices may be accomplished in a variety of ways, such as through the use of local area networks, wide area networks, cloud computing systems, internet based systems, and wireless communication systems.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to limit the invention, where like designations denote like elements, and in which:

FIG. 1 is a block diagram illustrating the interface for creating and sharing content between devices according to one embodiment of the present invention.

FIG. 2 is a block diagram illustrating the custom content according to one embodiment of the present invention.

FIG. 3 is a diagram of an exemplary network architecture configured to operate the methods according to the present invention.

FIG. 4 is a diagram of an exemplary device configured to operate the methods according to the present invention.

### DESCRIPTION OF PREFERRED EMBODIMENTS

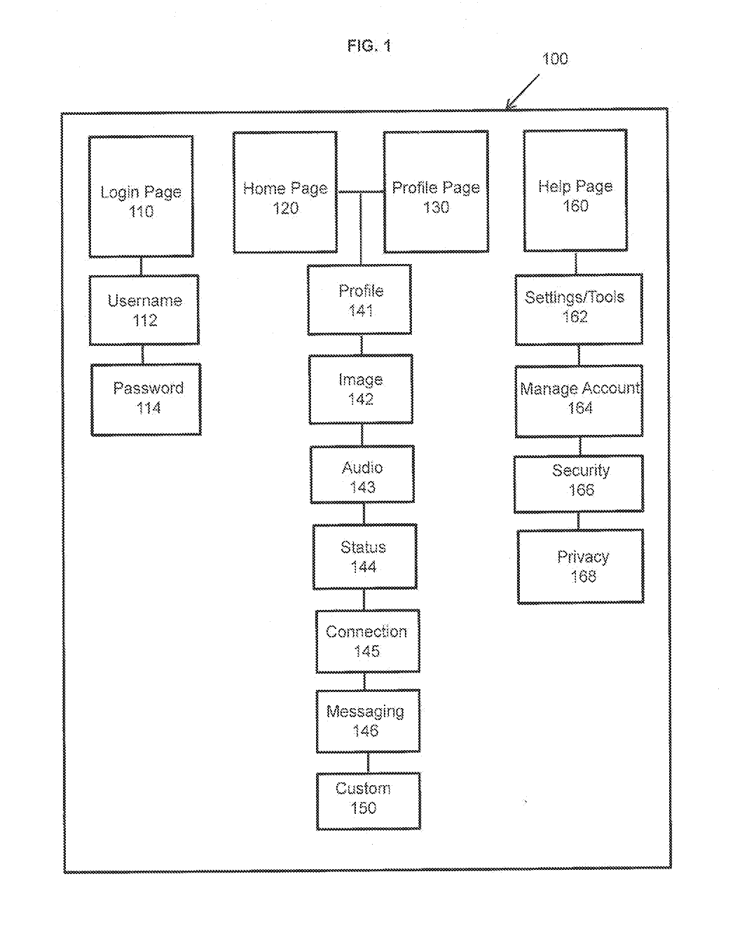

FIG. 1 is a block diagram illustrating the interface 100 to facilitate the creation and sharing of content between devices according to one embodiment of the present invention. The interface 100 is any system that permits users to interact with a software application using a device. It is contemplated that the interface 100 is a direct manipulation interface and more specifically may be a graphical user interface, web-based user interface, or touchscreen. The interface 100 allows users to interact with devices and ultimately with other users.

The interface 100 includes a login page 110, home page 120, profile page 130, and help page 160. The login page 110 allows the user to “sign-in” to access the software application by entering a correct combination of a username 112 and password 114. The login page 110 also permits a user to “sign-up” thereby enabling the user to access and interact with the software application. In order to “sign-up”, it is contemplated that the user provides identifying facts such as first name, last name, nickname, email address, password, gender, and birthday.

The login page 110 may further require all users to agree to certain terms and conditions before being granted permission to create and share content. For example, age restrictions may be imposed or the user may be required to review and accept certain terms and conditions before becoming a user.

The home page 120 of the interface 100 is the personal web page specific to the user. The home page 120 is private in that it is not accessible or viewable to the other users of the interactive platform. However, the home page 120 allows a user to create content that can be shared through the profile page 130, which is a web page viewable to other users of the social network. The help page 160 is a web page that assists a user with all aspects of the software application.

Content is anything created by the user. Various forms of content according to the invention are described below. Content is created by either generating new content or modifying existing content.

Profile content 141 is content that pertains to the user and that is specifically about the user. For example, profile content 141 may include a photograph of the user or an image related to the user as well as characteristics of the user and attributes of the truck driven by the user. Characteristics of the user include, for example name of the user, profession, employer, number of years of experience, total miles logged, estimated time of arrival at the destination, unique identity or nickname, age, employment history, state of residence, driver's license number, credit card number, picture, vehicle driven by the user, CB handle, hobbies, favorite sports team, generation data, etc. Generation data may include a family tree of the trucker illustrating the ancestry of family members subject to the trucking business. Significant events can be included in the generation data, such as the user's initiation into a union and other highlights or achievements such as becoming an owner-operator. Vehicle attributes may include information about the vehicle such as chassis, cab, axles, suspension, road wheels, engine, drivetrain and electrical systems.

Profile content 141 may also include any data that can be recorded and tracked such as vehicle data. Vehicle data may include the driver's log, fuel usage, speed, gear optimization, engine idle time, location, direction of travel, and amount of time spent driving.

As an example, the user home page 120 may allow the user to designate his or her favorite sports team. A helmet or hat illustrating the team's logo may be placed in a sport theme window to notify visitors to the user homepage of the user's favorite team. The sport theme window may also include several teams from different types of sports, if desired.

Image content 142 includes photographs and/or video. It is contemplated that a user can select a particular background image or style such as a western theme for the home page 120 and/or profile page 130 creating a personalized look and feel. Photographs and/or video may be presented in a gallery window, which can be segmented into different sections. For example, one section may include photos of different events such as “wildlife” and “road kill” of animals encountered during travel. Other sections may include scenic views, places visited, meetings with friends, etc.

Audio content 143 includes any audio recording such as voice messages, user selected song, live radio station, CB handle, or other broadcast. The home page 120 may include an audio link to facilitate the upload of the audio recording through a microphone. The audio content 143 can be intended exclusively for the user and remain on the home page 120 such as a reminder to pick up milk or can be intended for other users of the social network by sharing on the profile page 130 such as a documentary about a forest preserve. As another example, an audio recording such as a user selected song may be uploaded so that when a user's profile page 130 is accessed, the song is played. Optionally, the audio recording may be linked to a live radio station or other broadcast instead of a song. The audio recording could also stream the user's CB handle. It is also contemplated that the profile page 130 may include an audio link that allows other users to upload audio recordings.

Status content 144 identifies whether or not the user is active, online or available for communication with other users. Status content 144 may also designate what the user is doing, i.e., whether or not the user is on the road, sleeping, eating, on vacation, or if the user needs assistance such as help with repairing a flat tire, to name a few. Status content 144 may also include the precise location of the user such that the user “checks-in” to a specific venue, for example, when the trucker arrives at his or her final destination. The user can “check-in” manually or the interactive platform may include the capabilities that enable the user to “check-in” automatically.

Status content 144 may also include route specifics such as an illustration or text of when and where a truck driver is leaving, arriving, and returning. This information may be valuable for another user such as a broker or receiving company to track the specific location of the trucker and to monitor an estimated time of arrival (“ETA”).

It is contemplated that the status content 144 can include quick links that represent macros to identify certain actions, such as “waiting in line to pick up load”, “loaded and leaving shipper” and “arrived at final destination”. It is also contemplated that the macros can represent a variety of other information such as “sleeping”, “eating”, “in-transit” or “on the road”, or “leave me alone”. Status content 144 may be presented on the home page 120 or profile page 130 as an icon, text, symbol, or a button that when selected presents the status content 144 as aural speech.

Connection content 145 identifies users that are joined together or linked. Again, users may be individuals or entities including truck drivers, dispatchers, brokers, distributors, receiving companies, shipping companies, gas stations, rest areas, restaurants, hotels, mechanics, etc. A user can invite another user to accept a connection between them. Users that are joined together or linked enable the users to view the profile pages 130 of one another. Connection content 145 may be presented as text such as the name of the user. Connection content 145 may also be presented as images such as a picture of the user or an illustration selected to represent or signify the user.

Messaging content 146 identifies communications between users. Messaging content may include comments, statements, or announcements presented as text messages, voice mail messages, and video messages. Messaging content 146 may also include rating as provided by other users. For example, a receiving company may rate a trucker based on his or her actual arrival time as compared to his or her estimated arrive time. Messaging content 146 may also include a joke-of-the-day or horoscope.

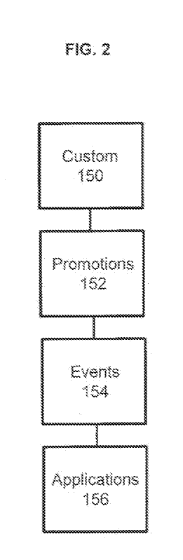

Custom content 150 is content custom to the user as illustrated more specifically in FIG. 2. Content can be customized based on the profile of the user, location of the user, or input provided by the user.

The help page 160 is available to users to assist with a variety of actions related to the interactive platform. For example, setting and tools 162 can be accessed to designate a particular language, select a time zone, and to manage font style and size as well as any other aesthetics of the interface 100.

Manage account 164 allows a user to change his or her username or password, permanently remove or temporarily deactivate their account, as well as perform user specific actions such as to organize the layout of their interface 100.

Security 166 allows a user to monitor current, pending and past threats such as malware, scams, viruses, and suspicious notifications.

Privacy 168 allows a user to edit preferences in order to control the content shared. Privacy 168 also allows users to block cookies from certain websites as well as control the cookies of the user's device that can be read by other devices.

FIG. 2 is a block diagram illustrating the custom content 150 according to one embodiment of the present invention. Custom content 150 based on the location of a user can be provided based on positioning data or tracking data of the user such as that provided by a global positioning system (“GPS”), an automatic vehicle location (“AVL”) or electronic ori-board recorders (“EOBR”).

Certain vehicles include on-board interfaces to communicate data such as real-time vehicle location utilizing a GPS. GPS is a space-based global navigation satellite system that provides location and time information of a vehicle. This information is particularly useful in trucking applications, for example, a truck driver may use the GPS to reach a certain destination. A special location tracking device also known as an AVL unit or EOBR are typically installed on trucks to automatically determine its position in real-time and to send the data to a remote computer database for visualization and analysis. The AVL unit often allows a driver to communicate with their dispatcher, who is normally responsible for determining and informing the driver of their pick-up and drop-off locations.

As illustrated in FIG. 2, custom content 150 may include promotions 152, events 154, and applications 156.

Promotion content 152 is advertising, incentives or discounts for retailer goods and services, for example, truck stops, motels, restaurants, truck maintenance facilities, entertainment, hair salons, spas, museums, casinos, etc.

Event content 154 is information such as times, prices, performers, related to certain concerts, shows, festivals, sporting events, theatres, amusement parks, etc.

Application content 156 is application software including application software for mobile devices to help the user to perform specific tasks. Application content may include applications for local or national news including real-time traffic reports and construction alerts as well as games.

It is contemplated that the credit card information of a user under the profile content 141 may be stored within the interactive platform such that a user can automatically make a purchase such as admission to a museum, tickets to a concert, a pair of shoes, a gaming application, etc.

A user publishes content to the profile page 130 by selecting the desired content and designating it as “posted”. Content posted to the profile page 130 is shared with other users of the social network and may include any of the content described above such as profile content 141, image content 142, audio content 143, status content 144, connection content 145, messaging content 146 and custom content 150.

Users of the interactive platform may search for other users based on the content posted on the profile page 130. For example, a user can search for other users that are in a specific city or users that have designated a specific sports team as their favorite. In this manner, users of the system may locate other users that share similar interests.

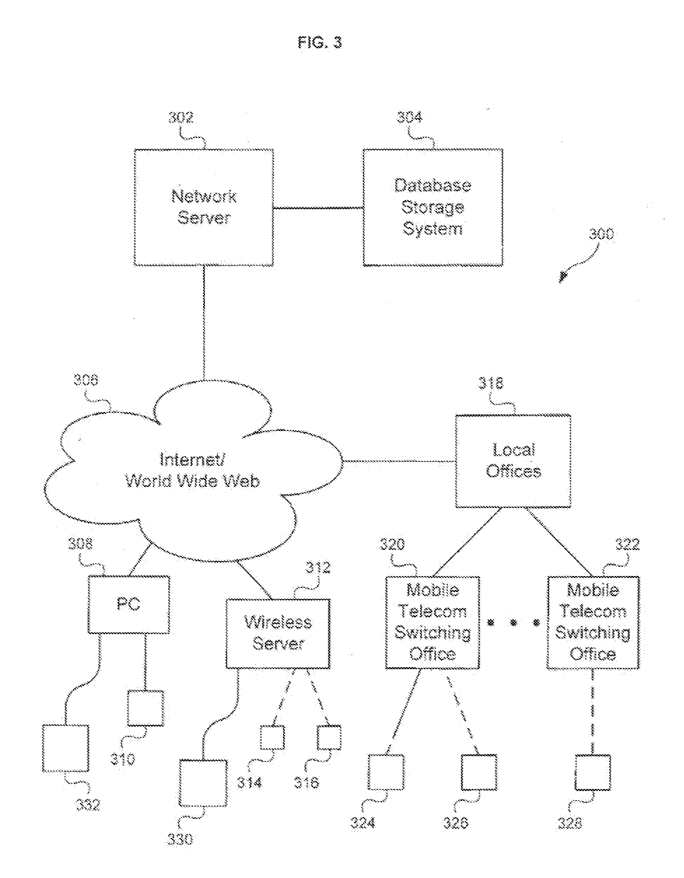

FIG. 3 is a diagram illustrating a network architecture 300 according to an example embodiment of the present invention. The network architecture 300 includes a network server 302 and a database storage system 304. The database storage system 304 stores the content of the users of the software application. The database storage system 304 may store the content in a relational database or other database. Network server 302 collects information including user content from the devices through the Internet 306. Network server 302 also collects data about the location or position of users and processes custom content to match users based on this data. While some or all of this data may be stored on individual devices and allow for ad hoc matching, the use of a network server 302 allows data about the location or position of users to be collected. For instance, the server 302 may determine the number of users at a particular truck stop and the number of users who are potential matches or whether linked friends are at that truck stop. A user may request this information in advance to decide whether or not to go to that particular truck stop.

Aggregated (or individual) location or position data may also be provided for purposes of evaluating advertising opportunities at a particular venue, for example, determining which ads should be provided to the user. Similarly, location or position data may be provided for purposes of providing event information, or suggested software applications such as games tailored to the user. The network server 302 can also be used to collect historical information about venues and the users who go there. Such information can be useful to third parties interested in knowing patterns, such as the users that frequent a particular venue and when. In addition, a user might want to know whether a given restaurant tends to be frequented by users who have friends in common with him.

In an example embodiment, the server 302 is connected to the Internet 306 for communications with other devices. In other embodiments, the server may be connected directly to a wireless network, cellular telephone system or other network. In the example embodiment, mobile devices 310, 314, 316, 324, 326 and 328 may be connected to the Internet (or other networks) through a variety of methods to allow communication with server 302 and other mobile devices. For instance, device 310 may be synchronized with a personal computer 308 that provides a connection to the Internet. Data may be exchanged with the server through the personal computer 308. In addition, content data may be entered through the personal computer 308 whether or not it is connected to particular mobile device. Similarly, data for a user profile may come from other networked devices 330, 332, such as a DVR, smart card, digital book reader, etc. Mobile devices 314 and 316 may also be connected to the network through a wireless server 312 that provides a connection to the Internet. For instance, wireless “hot spots” are increasingly being provided at truck stops, coffee shops, libraries other venues that may be visited by users of the interactive platform. Mobile devices 324, 326 and 328 may also be connected to the server 302 through a cellular telephone network. Mobile telecommunication switching offices 320 and 322 may use cellular telecommunications protocols (such as LTE, CDMA, GSM, TDMA or other protocol) to communicate with mobile devices 324, 326 and 328. The mobile telecommunication switching offices 320 and 322 may, in turn, be connected to the Internet 306 through local offices 318.

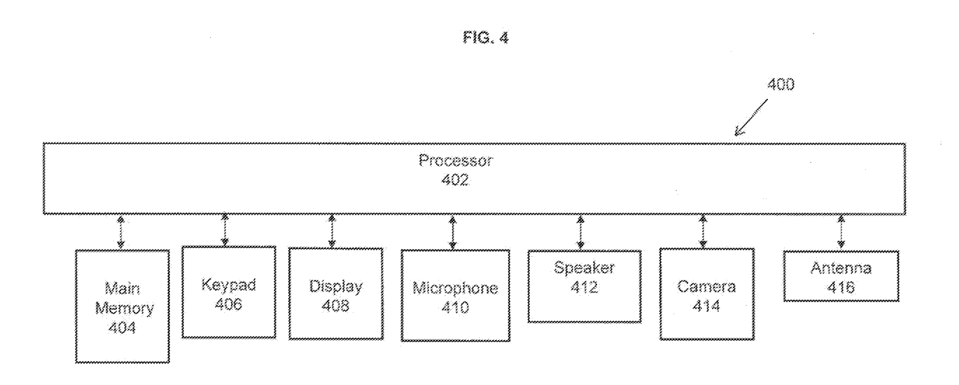

FIG. 4 is a diagram of an exemplary device 400 configured to operate the methods according to the present invention

One or more processors, such as processor 402, which may be a special purpose or a general-purpose digital signal processor, is connected the various components of the device 400.

A main memory component 404, for example random access memory (RAM), read-only memory (ROM), mass storage device, or any combination thereof enables the storage of information, data, and content. A keypad 406 may be either physical or virtual and facilitates the input of information, data, and content. A display interface 408, presents information, data, and content such that it is visible to the user. The display 408 can be a standalone unit or mounted to a vehicle. A microphone 410 enables input such as the recording of audio content whereas a speaker 412 enables sound output. Camera 414 enables input and output of image content. An external or internal antenna 416 enables communication between the device 400 and the network architecture such as that described in reference to FIG. 3.

Processor 402, main memory 404, and antenna 416 allow software and instructions to be transferred between the device 400 and network architecture 300. Software and instructions are typically transferred in the form of signals which may be electronic, electromagnetic, optical or other signals capable of being transferred between the device 400 and network architecture 300. Signals may be sent and received using wire or cable, fiber optics, a phone line, a cellular phone link, a Radio Frequency (“RF”) link or other communications channels.

The interactive platform is also directed to computer program products, otherwise referred to as computer applications, to provide software related to the interactive platform. Such software, when executed, implements the methods according to the present invention. Embodiments of the invention employ any computer useable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein can be implemented using software, hardware, firmware, or combinations thereof.

The network architecture 300 of FIG. 3 and the device 400 of FIG. 4 is provided only for purposes of illustration, such that the present invention is not limited to this specific embodiment. It is appreciated that a person skilled in the relevant art knows how to program and implement the invention using any device or network architecture.

The described embodiments are to be considered in all respects only as illustrative and not restrictive, and the scope of the invention is not limited to the foregoing description. Those of skill in the art will recognize changes, substitutions and other modifications that will nonetheless come within the scope of the invention and range of the claims.

1. A method for creating and sharing content through an interactive platform, comprising the steps of:
establishing communication between a network architecture and a first device and a second device;
receiving content specific to the trucking industry through a first interface of the first device;
transmitting the content specific to the trucking industry from the first device to a server of the network architecture;
accepting by the server of the network architecture the content specific to the trucking industry;
accessing by the second device the content specific to the trucking industry; and
displaying the content specific to the trucking industry on a second interface of the second device.

2. The method for creating and sharing content through an interactive platform according to claim 1, wherein the first interface and the second interface include a home page and a profile page.

3. The method for creating and sharing content through an interactive platform according to claim 1, wherein the first device is a mobile device.

4. The method for creating and sharing content through an interactive platform according to claim 1, wherein the first interface and the second interface include links that represent macros.

5. The method for creating and sharing content through an interactive platform according to claim 1, wherein the content specific to the trucking industry is one or more selected from the group comprising profile content, image content, audio content, status content, connection content, messaging content, and custom content.

6. The method for creating and sharing content through an interactive platform according to claim 1 further comprising the step of receiving by one of the first interface and the second interface an audio recording.

7. A method for creating and sharing content through interactive platform, comprising the steps of:
establishing a first communication link between a network architecture and an electronic on-board recorder positioned within a vehicle;
creating a second communication link between the network architecture and a mobile device;
transmitting vehicle data from the electronic on-board recorder to a server of the network architecture;
receiving by the mobile device the vehicle data from the server of the network architecture;
displaying the vehicle data on an interface of the mobile device.

8. The method for creating and sharing content through an interactive platform according to claim 7, wherein the vehicle data is one or more selected from the group comprising fuel usage, speed, gear optimization, engine idle time, location, direction of travel, and amount of time spent driving.

9. The method for creating and sharing content through an interactive platform according to claim 7 further comprising the step of using the vehicle data to evaluate advertising opportunities.

10. The method for creating and sharing content through an interactive platform according to claim 7 wherein the interface includes an Internet web page viewable by only one user and an Internet web page viewable by a plurality of users.
